(19) United States
(12) Patent Application Publication
(10) Pub. No.: US 2004/0246952 A1
(43) Pub. Date: Dec. 9, 2004

(54) Transmission apparatus

(76) Inventor: Takashi Honda, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/888,926

(22) Filed: Jul. 8, 2004

Related U.S. Application Data
(63) Continuation of application No. PCT/JP02/00717, filed on Jan. 30, 2002.

(51) Int. Cl. H04L 12/50

(52) U.S. Cl. 370/357; 370/241

(57) ABSTRACT

A transmission apparatus provided in a communication network and controlling connection in the circuit network, includes a signal switching part configured to output input signals provided to a plurality of input ports to a plurality of arbitrary output ports, respectively, and to arbitrarily set an operation line circuit and a line testing circuit.

### TECHNICAL FIELD

The present invention relates to a transmission apparatus, and, in particular, to a configuration by which a transmission apparatus which is used as a functional unit for line exchange or such in a communication network can be efficiently applied for line testing (test access).

### BACKGROUND ART

In a communication network, reliability itself is regarded as an important matter, and thus, in order to avoid a situation in which lines cannot be controlled properly due to some cause, line testing (called ‘test access’) is performed occasionally. The line testing is to prove a proper function of a relevant communication network, and is described next.

FIG. 1 shows a configuration in a state in which a communication network is operated regularly. There, three transmission apparatuses NEa, Neb and NEc are connected together. Thereamoung, the apparatus Neb has a line testing apparatus 50 connected thereto, and line testing operation is performed therewith. The apparatuses NEa and Neb are connected to backbone lines Nb, while the apparatus NEc is provided for access lines La. In the transmission apparatus Neb, so-called cross connect setting Ca is made for the access lines La.

FIG. 2 shows an example of connection according to a connection method called a MONE mode in a testing method standardized in a standard Telcordia Technologies Generic Requirements: GR-834-CORE (issued on Jun. 3, 2000), Telcordia Technologies: FR-476, or such. In this case, a line from the access lines La is connected to the testing apparatus 30 via an E (for an apparatus on the side of a subscriber) port by means of testing connection Ta, and therewith, a condition in the access lines is monitored with the testing apparatus 50 for the purpose of testing.

FIG. 3 shows a connection example according to a connection method called a MONEF mode in the above-mentioned standard. In this case, by means of testing connection T, the access lines are monitored with the use of the E port while the backbone lines are monitored with the use of an F port, from the testing apparatus 50.

FIG. 4 shows a connection example according to a connection method in a SPLTE mode. In this case, the cross connect Ca on operation is opened, and switching is performed for connection to the E ports. Then, a testing signal is transmitted with the use of the E ports, a response signal thereto is measured, and thus, the access lines is tested with the testing apparatus 50.

FIG. 5 shows a connection example according to a connection method in a SPLTEF mode. Also in this case, the cross connect Ca on operation is opened, and switching is performed for a connection to the E ports and to the F ports, respectively. Then, testing signals are transmitted with the use of these ports, response signals thereto are measured, and thus, the access lines and the backbone lines are tested with the testing apparatus 50.

FIGS. 6 and 7 illustrate a mounting state in an interface board in such a transmission apparatus NE. As shown, in the transmission apparatus NE, in the related art, a position for mounting high-order group (backbone side) interface cards and a position for mounting low-order group (access side) interface cards are predetermined in the apparatus. Furthermore, as shown in FIGS. 8A and 8B, in the transmission apparatus NE, special cross-connect units are provided for respective particular signal transmission directions.

FIG. 9 illustrates an assumable connection state in the transmission apparatus NE at a time of executing line testing (test access) operation mentioned above with reference to FIGS. 1 through 5. IFn and IFm denote interface cards, respectively, mounted in the transmission apparatus NE; SLj denotes a switching unit having a cross-connect function also mounted in the transmission apparatus NE; and SLi denotes a selector unit provided specially for line testing operation and is inserted in a relevant slot of the transmission apparatus NE to be used at a time of testing.

In the related art described above, in a case where the interface card IFn acts as an interface used for lines to be actually tested now, an operator should be dispatched to a relevant location at which this transmission apparatus NE is installed, and the operator then operates appropriately a change over selector provided in the interface card IFn for switching between testing lines and operation lines, into the side of the testing line. Thereby, original connection to the switching unit SLj is switched into connection to the selector unit SLi in the interface card IFn. Thus, according to the related art, somewhat troublesome operations are needed for preparing for the testing such as to insert the selector unit for testing into the transmission apparatus NE, perform the switching operation on the change over selector switch on the interface card, and so forth.

### SUMMARY OF THE INVENTION

The present invention has been devised in consideration of the above-mentioned problem, and an object of the present invention is to provide a configuration by which, without specially providing cards for line testing, line testing ports (such as those Pt shown in FIG. 9) or such, connection for line testing operation can be established easily by changing setting in interface cards or ports which are those normally used for regular operation.

For this purpose, according to the present invention, a signal switching arrangement is made such that input signals provided to a plurality of input ports can be output to a plurality of arbitrary output ports, respectively, and an operation line circuit or a line testing circuit can be arbitrarily set therein. Furthermore, connection circuit setting operation performed by the signal switching arrangement is achieved actually by means of operation of setting a software program. Furthermore, the signal switching arrangement is configured such that a plurality of change over switching parts are disposed in a matrix manner therein.

In such a configuration, there is no discrimination on each unit or each port as to what purpose it should be used, i.e., whether it should be used for regular operation or testing; or, whether it should be used for backbone lines or for access lines. These parts/components may be used for an arbitrary purpose by means of setting operation performed merely when it is actually used on a software program which is provided for controlling the signal switching arrangement. Thereby, such a configuration of the transmission apparatus can be applied for any operation situation or testing situation. Thus, it is possible to remarkably improve the flexibility in the transmission apparatus.

Furthermore, since cross connect setting can be made arbitrarily by means of software setting operation, the following advantage can be obtained: In a case where a transmission apparatus located at a remote location is to be tested, circuit connection setting for testing can be achieved by means of remote operation without a need of dispatching a testing staff or such to the remote location. There, cross connect setting in the signal switching arrangement in the relevant transmission apparatus is controllable from another transmission apparatus present locally. Thus, it is possible to remarkably reduce labor of testing staffs, and to improve efficiency in the line testing operation.

### BRIEF DESCRIPTION OF THE DRAWINGS

FIGS. 1 through 5 show examples of circuit connection manners in line testing operation in the related art;

FIG. 6 shows an example of connection manners for backbone lines and access lines in a transmission apparatus provided in a communication network in the related art;

FIG. 7 shows positions in which line connecting interface cards are mounted in the transmission apparatus shown in FIG. 6;

FIGS. 8A and 8B illustrate examples of arrangement of connection ports in cross connect units provided in the transmission apparatus;

FIG. 9 shows an example of a circuit connection manner in the transmission apparatus when line testing is performed;

FIG. 10 illustrates an internal configuration in a transmission apparatus according to an embodiment of the present invention;

FIG. 11 shows a slot arrangement in the transmission apparatus shown in FIG. 10 and a port arrangement in an interface card inserted into each slot;

FIG. 12 shows an example of how a BLSR cross connect matrix unit is used in the configuration shown in FIG. 10;

FIG. 13 illustrates operation of detecting a disconnection in an external connection cable in the transmission apparatus and generating an interrupt for a CPU of a control part in the configuration shown in FIG. 10;

FIG. 14 shows an example of a connection manner between the transmission apparatus according to the embodiment of the present invention and a line testing apparatus;

FIG. 15 shows an example of a state in which TAP for line testing is set in the configuration shown in FIG. 10;

FIGS. 16A and 16B illustrate an example of configuration of table information prepared for performing TAP setting shown in FIG. 15;

FIG. 17 shows an operation flow chart for setting TAP shown in FIG. 15;

FIG. 18 shows an operation flow chart for deleting data setting TAP shown in FIG. 15;

FIG. 19 illustrates an example of a connection manner performed when line testing is performed for a transmission apparatus located remotely;

FIG. 20 shows an example of a specific manner of connection setting in a transmission apparatus present locally for performing line testing for a transmission apparatus located remotely;

FIG. 21 illustrates an example of a line connection manner performed in a case where, with the use of the transmission apparatus according to the present invention, line testing is performed for a network having a DCP configuration;

FIGS. 22 through 24 show examples of connection setting manners in the transmission apparatus for illustrating a case where line testing is performed for the circuit having the DCP configuration, according to the present invention; and

FIG. 25 shows an operation flow chart for detecting removal of a line testing cable connected to the transmission apparatus according to the present invention and generating an interrupt.

### BEST MODE FOR CARRYING OUT THE PRESENT INVENTION

Embodiment of the present invention will now be described with reference to figures.

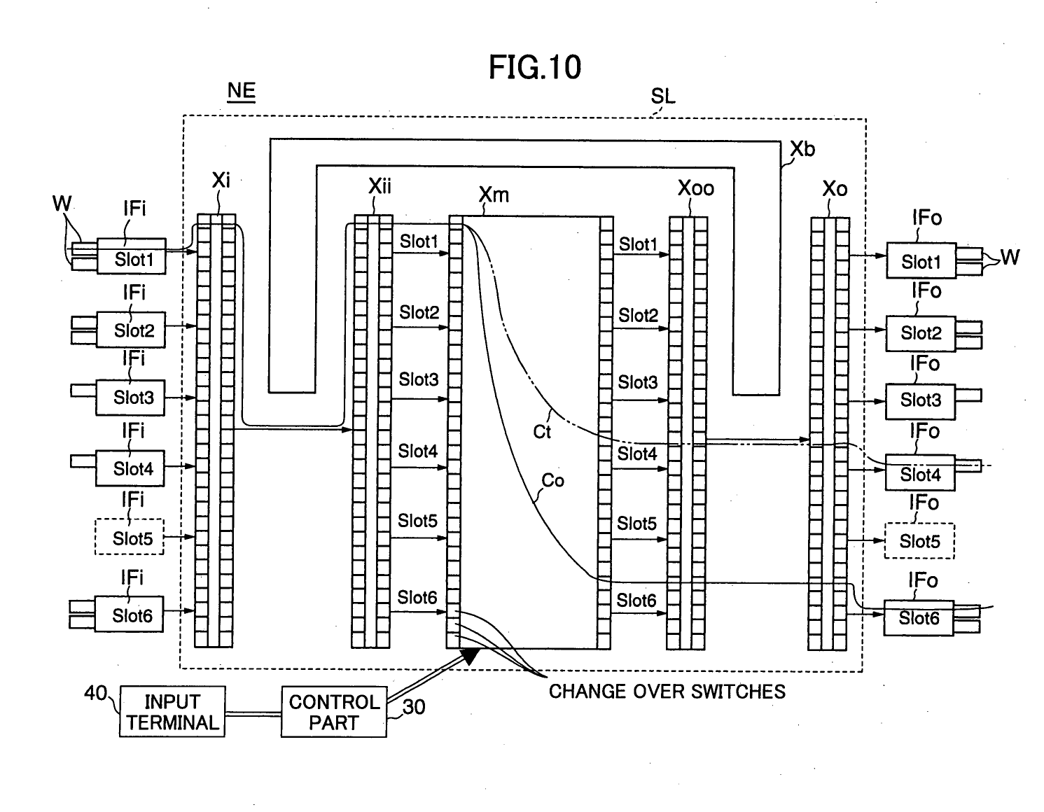

FIG. 10 illustrates a configuration of a transmission apparatus NE according to one embodiment of the present invention.

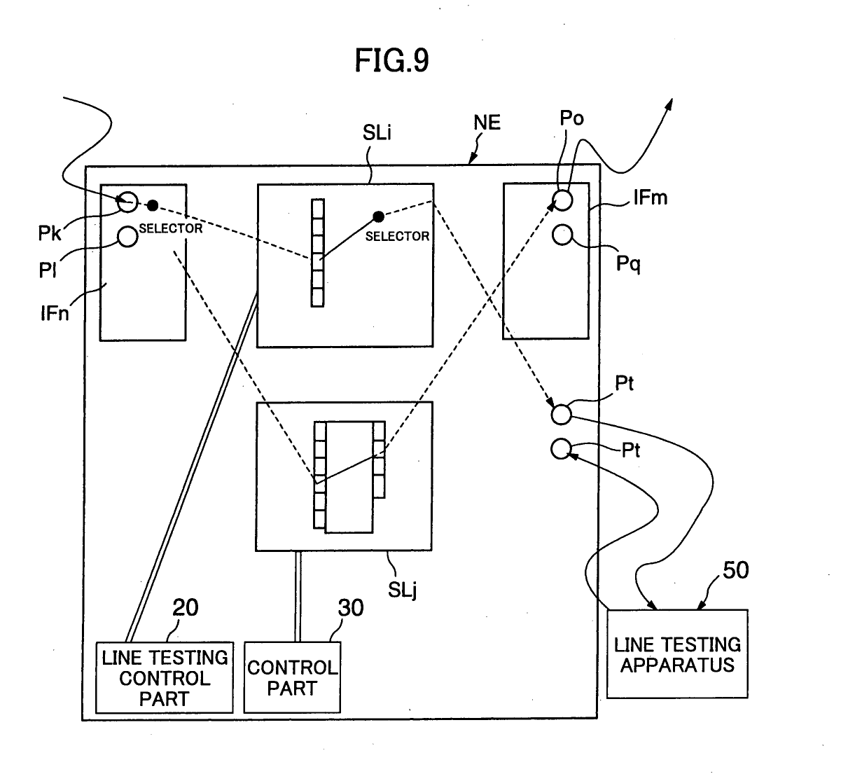

The transmission apparatus NE shown includes a switching unit (cross connect matrix unit) SL, corresponding to the switching unit SLj in FIG. 9 or such, input-side interface cards IFi, corresponding to the interface cards IFn and IFm, and output-side interface cards IFo. The interface cards IFi, IFo and the switching unit SL are inserted into slots provided in the transmission apparatus, respectively.

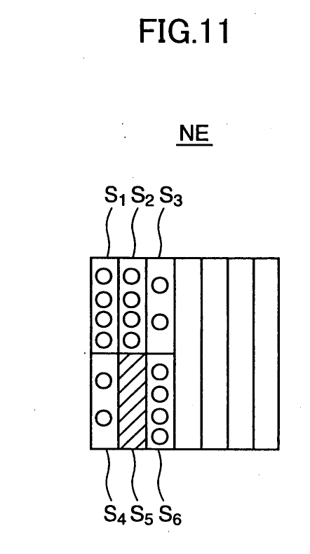

FIG. 11 shows a configuration of such slots provided in the transmission apparatus NE. In the figure, areas divided into rectangles represent the respective slots, and, as a result of the above-mentioned switching unit, interface cards and so forth being inserted into the respective slots, the transmission apparatus NE is completed. In the figure, circles represent external connection ports provided in these interface cards thus inserted into the slots of the transmission apparatus NE.

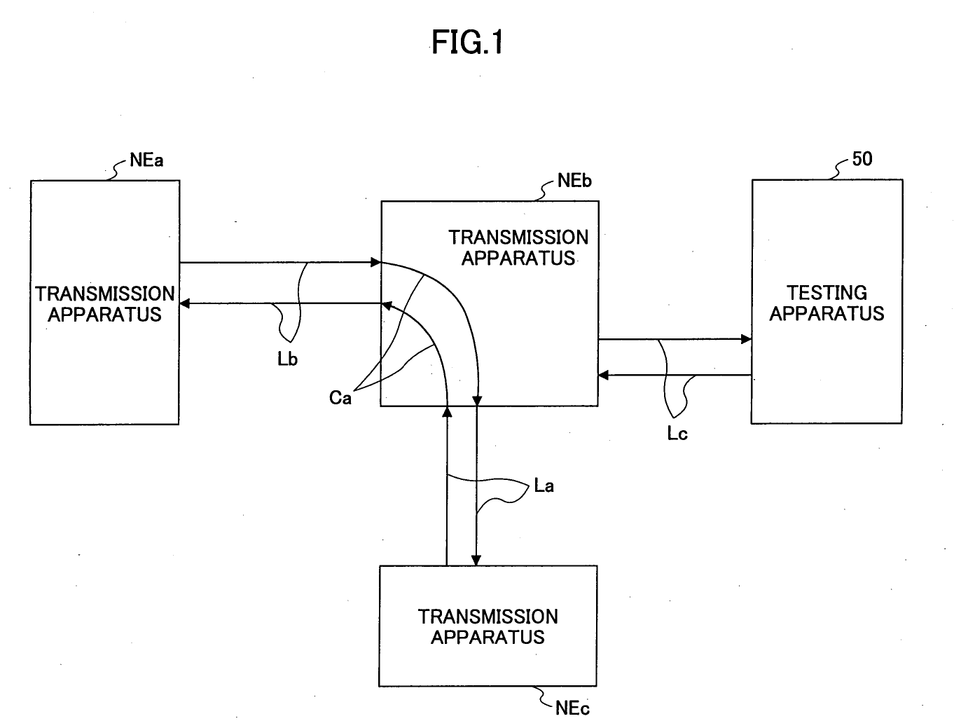

In FIG. 10, among the respective interface cards IFi and IFo, cards having common slot numbers, i.e., each of Slot1 through Slot6, have integral configurations actually, and are inserted into a respective one of the slots S₁ through S₆. As shown, in FIGS. 10 and 11, the slot Slot5 is in a vacant state, and thus, no interface is mounted therein. Further, external cables W, acting as respective lines shown in FIG. 1 or such, are connected to the respective interface cards via the above-mentioned ports.

Returning to FIG. 10, the above-mentioned switching unit SL actually includes an input-side cross connect matrix unit Xi, a central cross connect matrix unit Xm, an output-side cross connect matrix unit Xo, intermediate cross connect matrix units Xii and Xoo inserted therebetween, and a cross connect matrix unit Xb functioning as a BLSR (bi-directional line switching ring) switch. As shown, the input-side cross connect matrix unit Xi is connected with the input-side interface cards IFi while the output-side cross connect matrix unit Xo is connected with the output-side interface cards IFo. Further, the respective cross connect matrix units Xi, Xii, Xm, Xoo and Xo and the cross connect matrix unit Xb acting as the BLSR switch are connected by means of predetermined wiring therebetween.

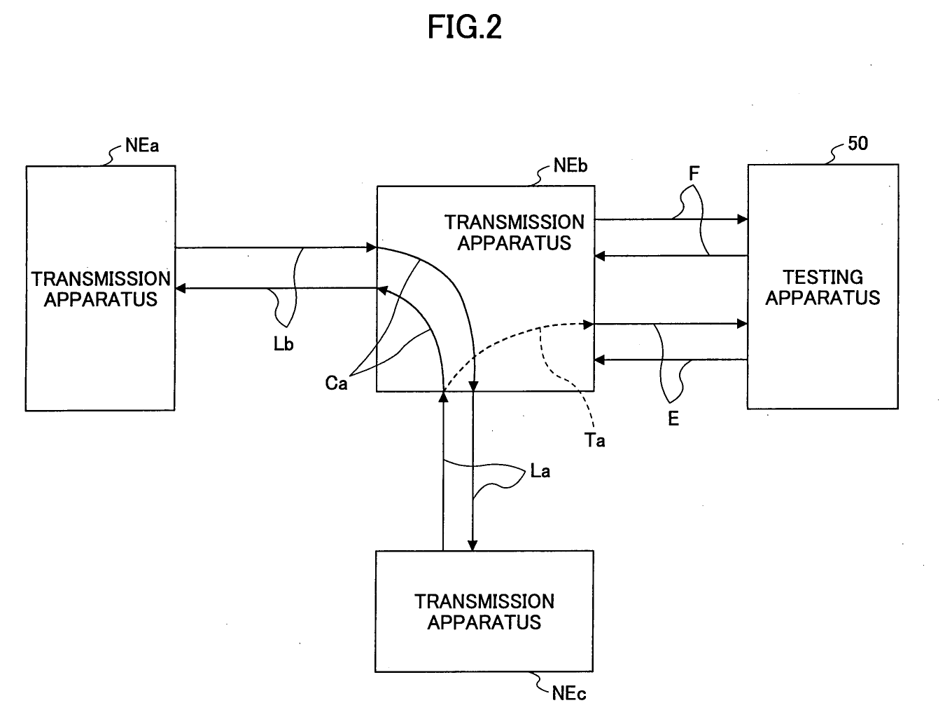

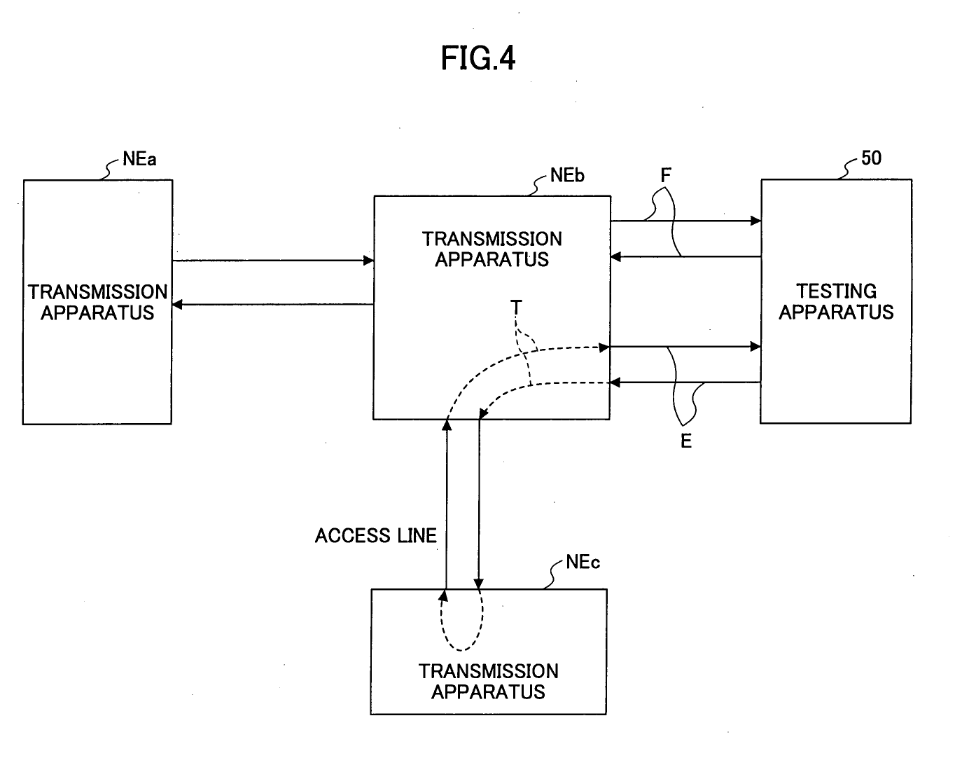

Each of these cross connect matrix units is made up of a collection of change over switches, and the respective change over switches are disposed and mutually connected in a matrix manner. In FIG. 10, other than the unit Xb, the change over switches in input/output parts are represented by rectangles. As to the unit Xb, the respective change over switches are completely omitted in the figure. The number of the change over switches arranged vertically corresponds to a total number of paths accomodateable by the respective ports of the input/output interface cards. Thus, cross connect setting can be achieved thereby for the number of lines corresponding to the above-mentioned number of the change over switches. Further, operation of these cross connect matrix units, i.e., the cross connect setting operation is controlled by means of a control part 30 according to an external signal input via an input terminal 40 with the use of software. By such control operation, it is possible, for example, to make an arbitrary cross connect setting such as regular operation cross connect setting indicated by a solid line Co or testing cross connect setting indicated by a chain double-dashed line Ct (corresponding to the cross connect setting T or Ta shown in FIGS. 1 through 5, for example).

Thus, according to the present invention, at least the central cross connect matrix unit Xm has no fixed relationship with actual respective signals transmitted through the slots, ports and paths, and, such a relationship can be arbitrarily set for each particular condition. By thus removing a limitation concerning hardware, it becomes possible to set and register each interface card and each port freely as a TAP (test access port) which is a physical interface for line testing (test access) as described later. As a result, it becomes unnecessary to prepare a special line testing interface card (IFn in FIG. 9, for example) or such, while it is possible to use in common a regular-operation-use interface card for a testing purpose. Accordingly, it is possible to effectively reduce the costs required for performing line testing (test access).

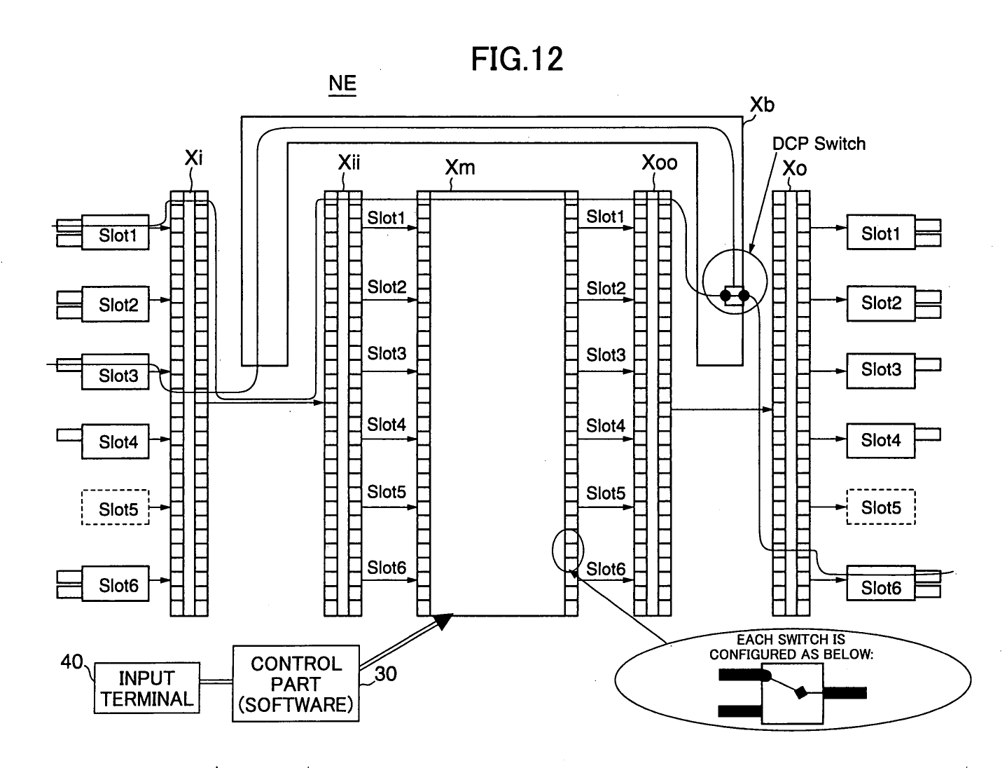

Further, in a case where testing is performed on a path employing a predetermined selector thereon, the above-mentioned cross connect setting should be performed in such a manner that a selector configuration same as the selector for a path switch may be established therein. Thereby, a configuration required for relevant testing operation can be achieved. Such an application is enabled since, in the cross connect matrix unit, the change over switches having the configuration of matrix mentioned above are provided for all the paths. FIG. 12 shows an example in which a DCP (drop and continue on protection) switch configuration, which is an example (described later) of the above-mentioned selector configuration, is established in the transmission apparatus in the embodiment of the present invention described above.

Information concerning the above-mentioned setting for the testing mode according to the standard performed by a user may be preferably recorded in a predetermined non-volatile memory included in the control part 30, and therewith, change in the testing mode setting performed by a person other than the setting user is avoided. Specifically, such operation of avoiding setting change operation by another person can be achieved as a result of such setting information being registered for each particular user (described later). In such a configuration, it is also preferable to provide a configuration by which the thus-recorded setting information can be deleted by anybody in a predetermined situation. Thereby, even in a case where a user who once made such setting operation comes to be not able to access the control apparatus 30 for some reason or a similar situation occurs, the relevant information may be deleted by another person, and thus, it is possible to avoid a problematic situation in which predetermined operation is left not utilizable unnecessarily for a long period.

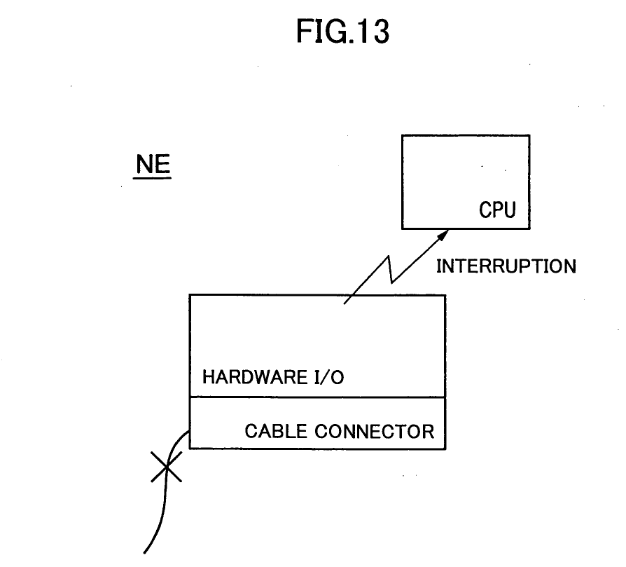

Furthermore, it is preferable to provide a configuration such that, in a case where connection to a port from which a command is input is disconnected (due to accidental removal of a LAN cable or such) by some cause, an interrupt is generated for a CPU of the control part 30 so that the CPU can recognize the disconnection situation, and thereby, the CPU cancels the relevant line testing state, under the control of software. FIG. 13 illustrates this scheme. Such testing state cancellation processing can be achieved, for example, as a result of previously providing two databases as cross connect setting databases, i.e., a database including line testing data and a database without including the same data, inside of the control part 30. Then, control is made in this case such that, when it is necessary to cancel the testing state, the above-mentioned database without including the line testing data is activated selectively.

The above-described configuration is described next in further detail.

First, a configuration by which slots and ports used for regular operation line connection are then set to be used specially for line testing (test access) or the once made setting is cancelled by means of setting of a command of TL1 (transaction language 1), is described. Specifically, for predetermined ports, arbitrary numerals can be designated for test access ports (TAP), where it is determined that only the numeral ‘0’ is not used as TAP. Accordingly, which numeral is designated as TAP is recognized internally, and, when any numeral other than ‘0’ is designated, it can be determined that the relevant port is allocated as TAP accordingly.

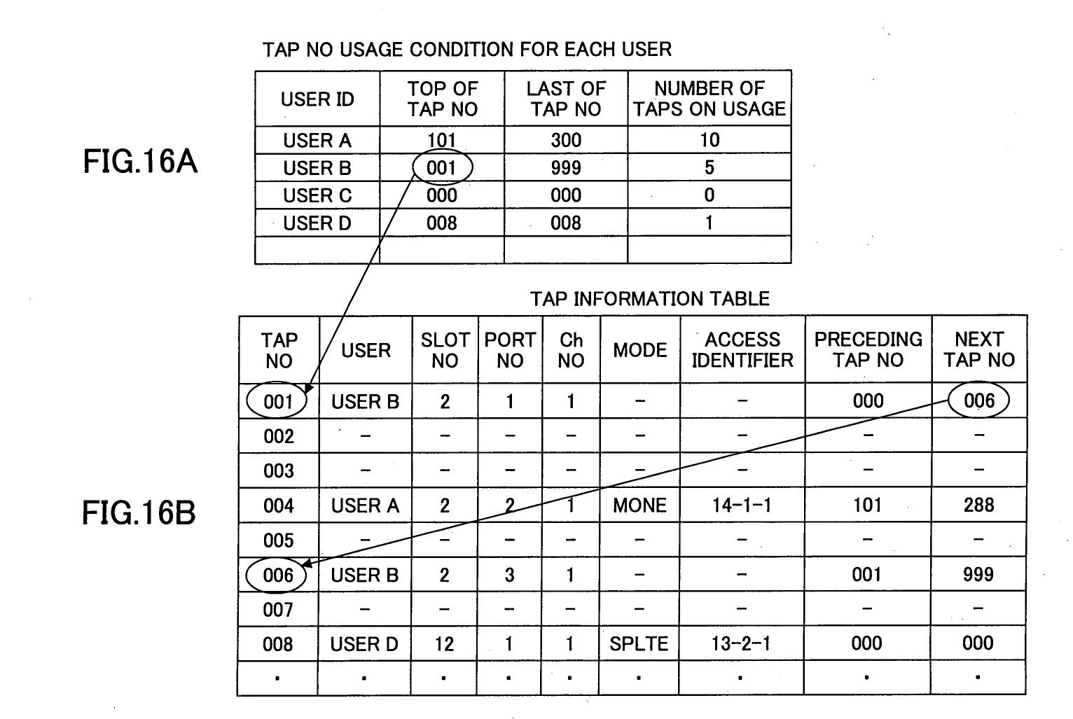

By previously registering TAP (as described later with reference to FIGS. 16A and 16B, for example), it is possible to distinguish respective ports as those used for regular operation and those for testing purpose, and thus, it is possible to avoid a problematic or dangerous situation in which ports specially used for testing are erroneously used for another purpose, a signal coming from a testing-use port is erroneously fed to an operation line, or such.

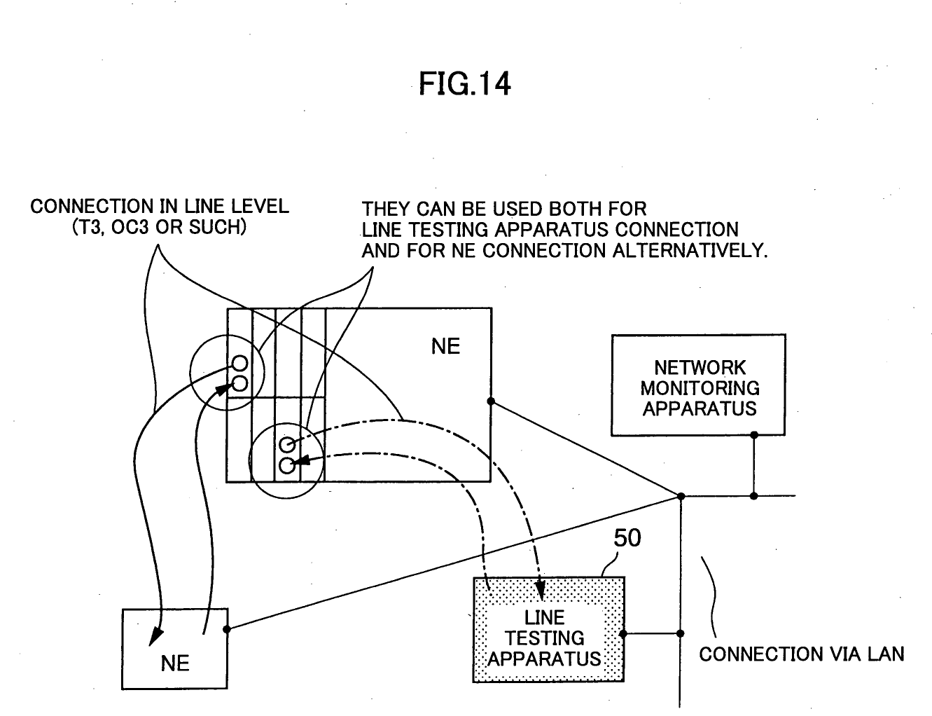

For example, the line testing apparatus 50, the transmission apparatus NE and the network monitoring apparatus are connected as shown in FIG. 14.

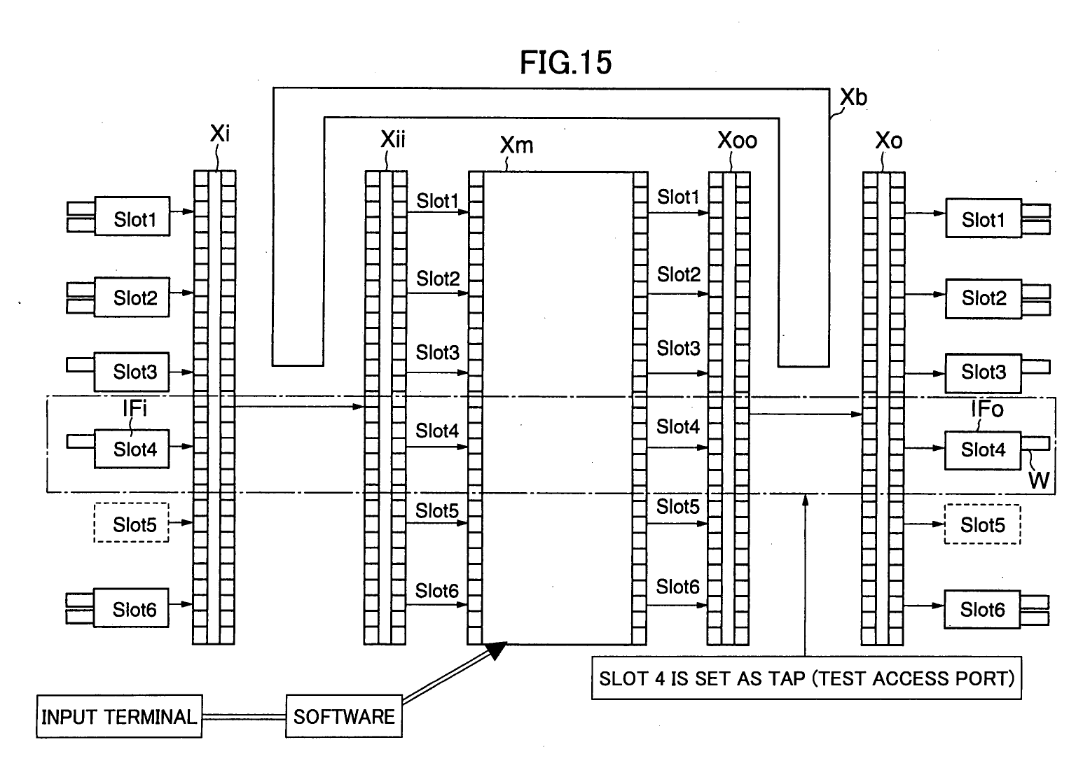

There, for example, a port 1 in the slot Slot4 is set as TAP, and the TAP in the hardware within the transmission apparatus NE is set as shown in FIG. 15. Then, all the I/O corresponding to the thus-set slot Slot4 are recognized as TAP. Thus, merely recognition in the software should be changed internally while there exists no discrimination in the hardware itself for the purpose of TAP setting.

FIGS. 16A and 16B illustrate configurations in tables (table information) used for performing TAP registration or TAP setting. As shown, a table shown in FIG. 16A for registering states as to how TAP Nos. are used for respective user IDs, and a TAP information table shown in FIG. 16B are recorded as registration information in the control part 30. Therewith, the following management operation is enabled to be performed.

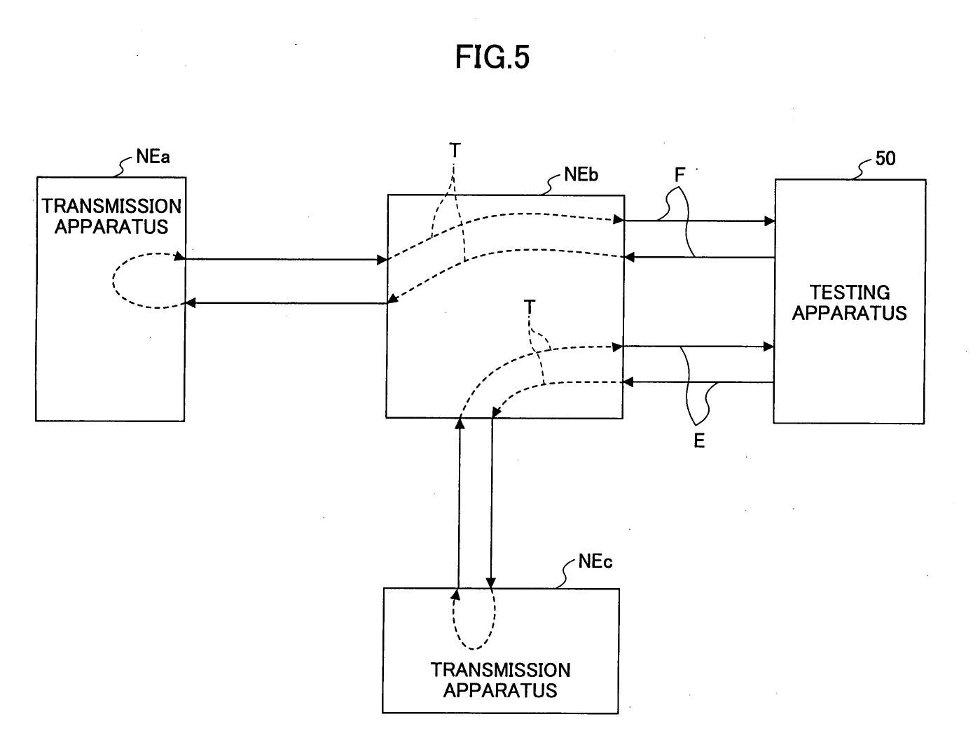

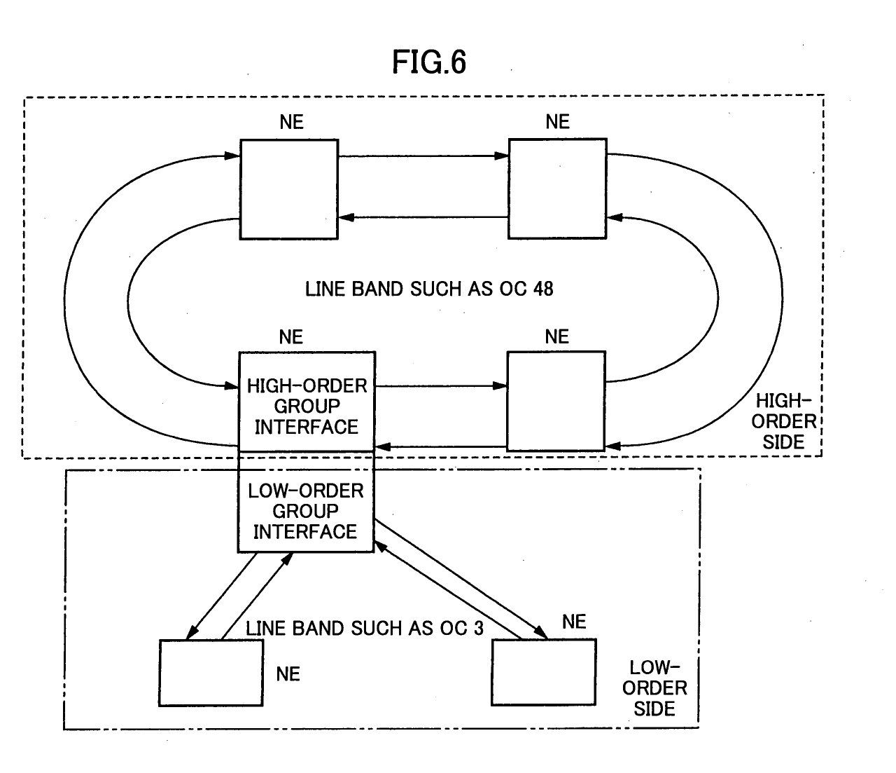

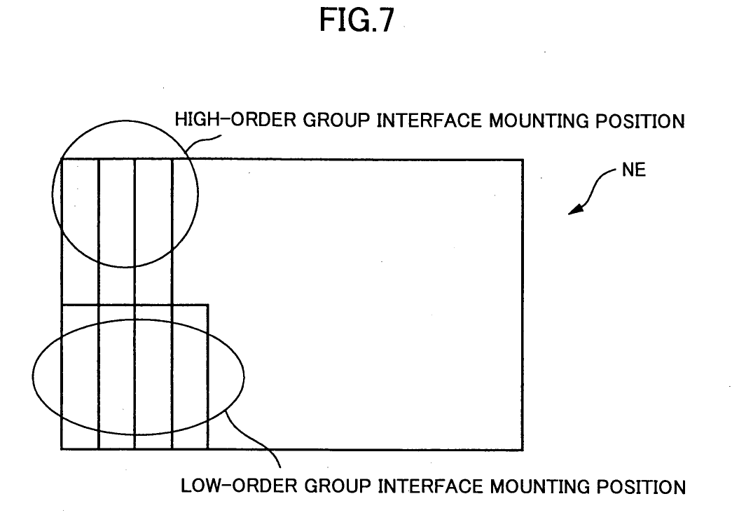

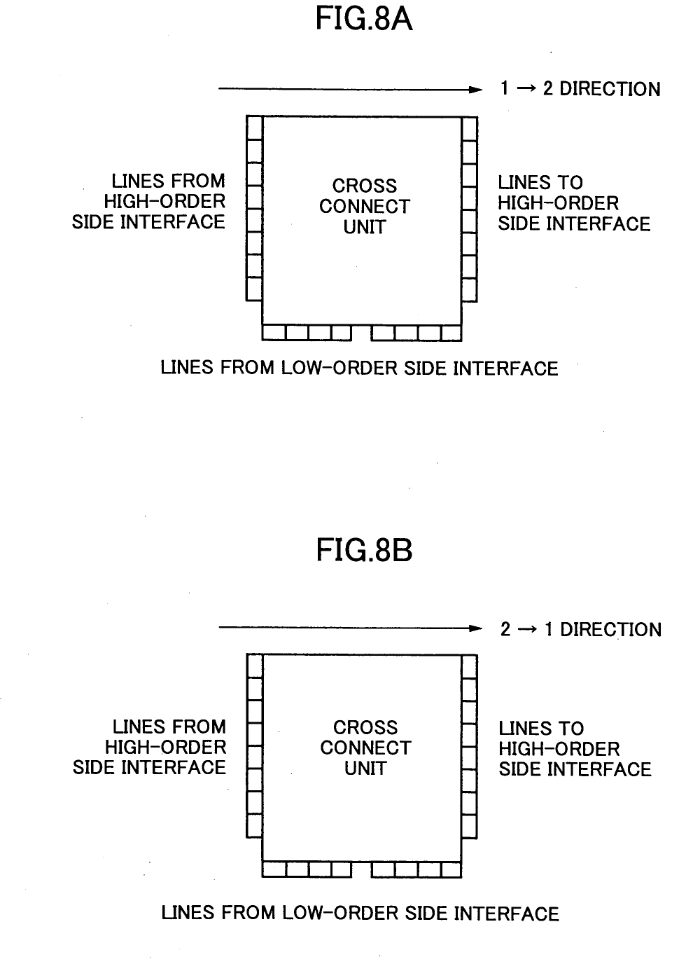

There are a plurality of types of connection setting for line testing (test access), i.e., connection modes such as the above-mentioned MONEF, SPLTEF and so forth. In a mode such as SPLTEF, operation is performed in which operation lines through which signal transmission/reception is performed are once disconnected, and then, connection thereof to the TAP is performed, as shown in FIG. 5. If such connection to the TAP is performed on lines actually on operation erroneously, a serious problem may occur such as unexpected live operation line break. In order to avoid such a problematic situation, it is preferable that change in such a testing connection mode can be performed only by a user who originally set the mode, by means of, for example, providing a system requiring a user ID or such as a log-in requirement. Furthermore, it is preferable to provide a configuration by which cross connect setting change on a port for which TAP setting has been already made is not achievable, and manual cross connect change is not achievable, whereby setting change during the testing is made not achievable, and thus, a relevant problem can be positively avoided.

With the use of the tables shown in FIGS. 16A and 16B or such, it is possible to manage which ports are used by respective particular users. There, it is preferable to provide a configuration in software by which when a testing mode is changed, it is determined whether or not a user who currently requests the testing mode change is identical to the user who originally set the testing mode, by means of a user ID identification system or such. In this configuration, if the above-mentioned identification determination results in failure, i.e., the user's identification has not been proved, the relevant request is rejected.

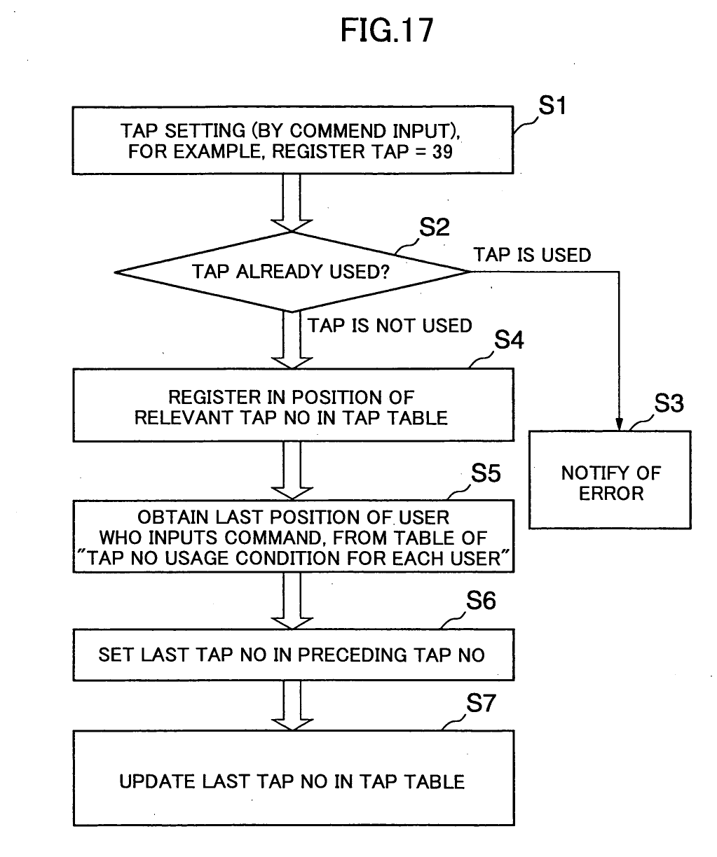

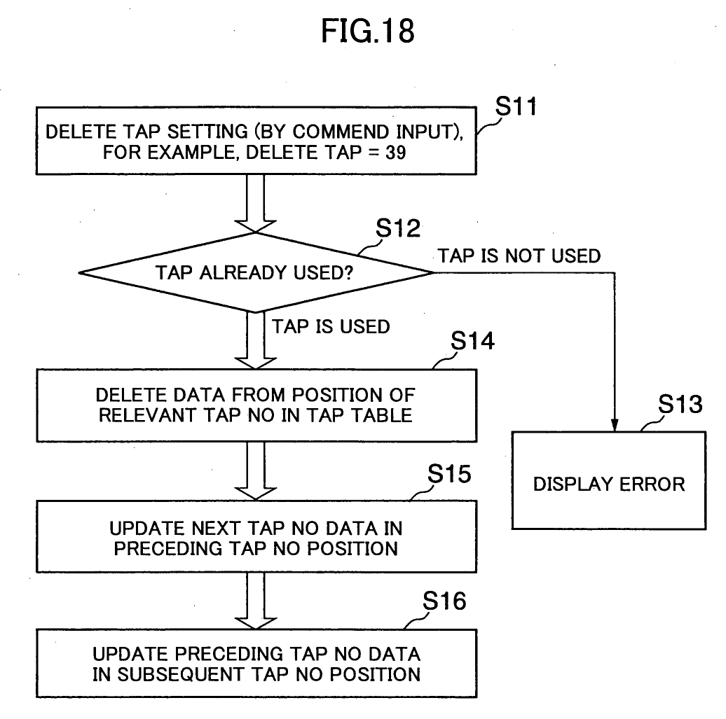

Algorithm for using the above-mentioned respective tables is described next with reference to FIGS. 17 and 18.

FIG. 17 shows TAP setting operation. In this case, it is assumed that cross connect setting is made for a user who already has cross connect setting in the relevant transmission apparatus NE, and then adds new cross connect setting for adding new cross connection with the use of a new TAP number. When a relevant TAP setting command is input by the user in Step S1, it is determined whether or not the relevant TAP number included in the command is one already registered in the tables in Step S2. When no relevant registration exists there as a result, new TAP setting is registered in the relevant position (line corresponding to the above-mentioned TAP number designated) in the TAP information table shown in FIG. 16B in Step S4. Then, in Step S5, the last TAP number of the relevant user is obtained from the table of TAP NO USAGE CONDITION FOR EACH USER shown in FIG. 16A. Then, the thus-obtained last TAP number is set as the preceding TAP number of the relevant position (line corresponding to the above-mentioned new TAP number) in the TAP information table shown in FIG. 16B in Step S6. Then, finally, in Step S7, the currently applied new TAP number is set as the last TAP number in the table shown in FIG. 16A.

FIG. 18 shows TAP setting deletion operation. In this case, it is assumed that cross connect setting is deleted for a user who already has the cross connect setting in the relevant transmission apparatus NE, and then deletes the cross connect setting which is part of the cross connect setting the user already has. When a relevant TAP setting command is input by the user in Step S11, it is determined whether or not the relevant TAP number included in the command is one currently registered in the tables in Step S12. When the relevant registration exists there as a result, the TAP setting in the relevant position (line corresponding to the above-mentioned TAP number) in the TAP information table shown in FIG. 16B is deleted in Step S14. Then, in Step S15, the preceding TAP number in the position (line) from which the TAP has been thus deleted is referred to, and, the next TAP number in the relevant position (line) in the TAP information table indicated by the TAP number thus referred to is updated with the next TAP number of the position (line) for which the TAP setting has been deleted. Similarly, in Step S16, the next TAP number in the position (line) for which the TAP setting has been deleted is referred to, and, the preceding TAP number in the relevant position in the TAP information table indicated by the TAP number thus referred to is updated with the preceding TAP number of the position (line) for which the TAP setting has been deleted.

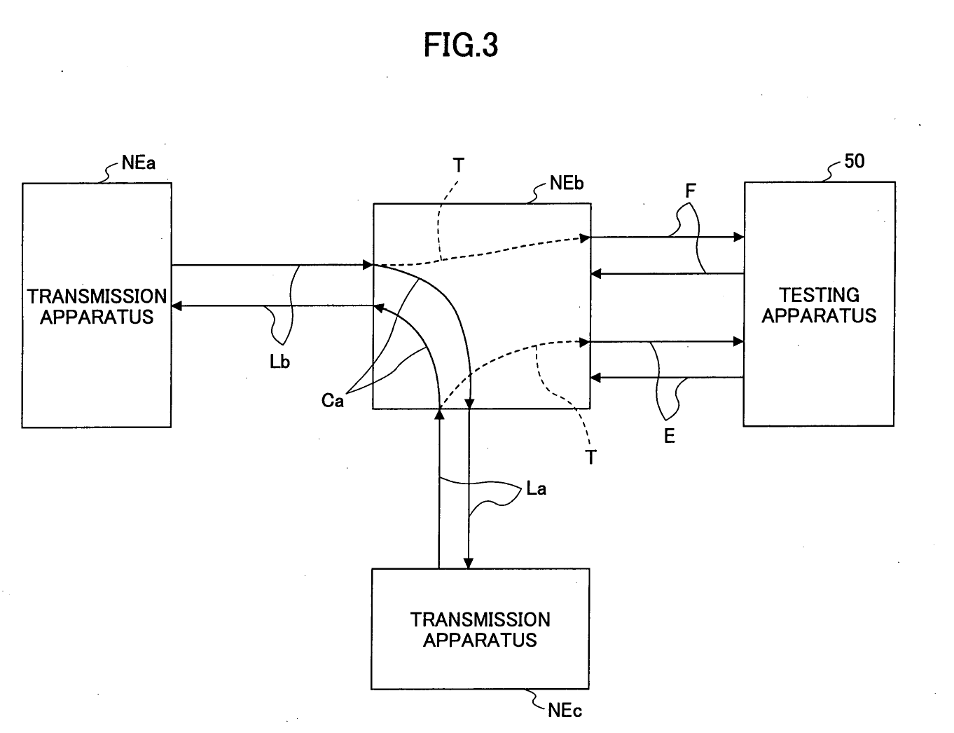

According to the related art, as shown in FIG. 3 or such, there is a rule of line testing (test access) in which a test is performed in a condition in which subscriber-side (access-side) lines are connected to the E ports while backbone-network-side lines are connected to the F ports. However, according to the present invention, any ports can be used either as the E ports or as the F ports in the transmission apparatus. That is, according to the present invention, as mentioned above, the configuration is provided such that TAP setting can be freely made through software setting. Thereby, it is not necessary to provide a limit on setting of the F ports or the E ports; ports to be applied for line testing (test access) are determined by means of software setting, as to which ports are applied as test access ports (TAP), and thus, it is not necessary to distinguish TAP depending on which type of test the TAP are actually used.

Such a configuration can be achieved by providing hardware by which it is possible to select any path to be actually applied for an output path, from among all the input paths. Such a type of hardware can be provided by means of a cross connect matrix unit such as that shown in FIG. 10. With the use of such hardware, cross connect setting can be arbitrarily changed by means of software setting, and thus, such a type of hardware by which cross connect setting can be flexibly made can be achieved.

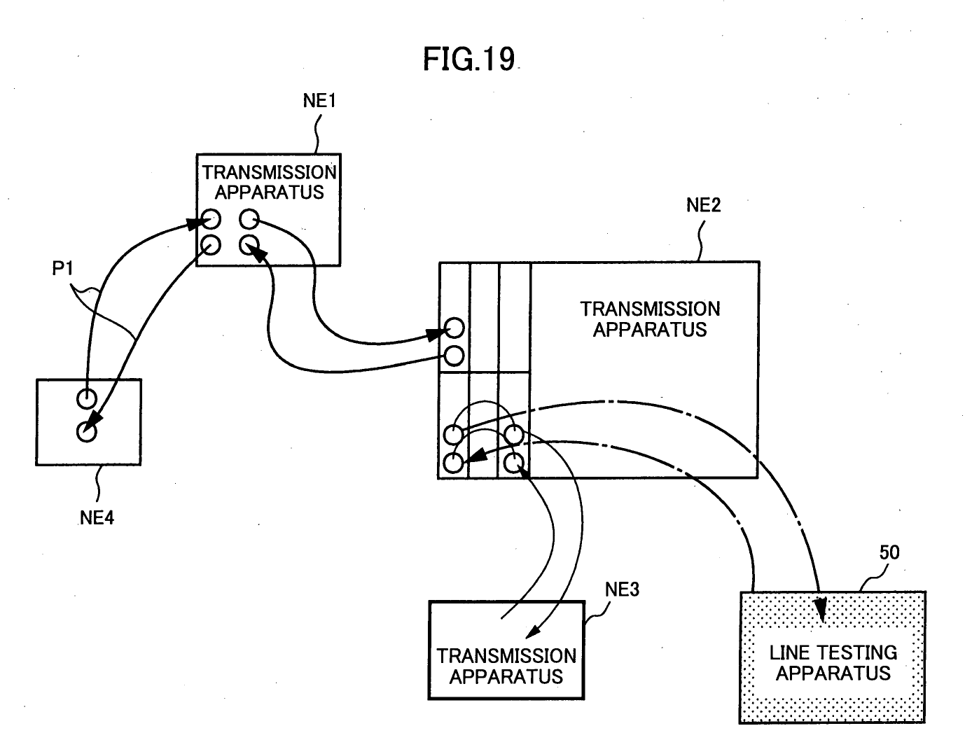

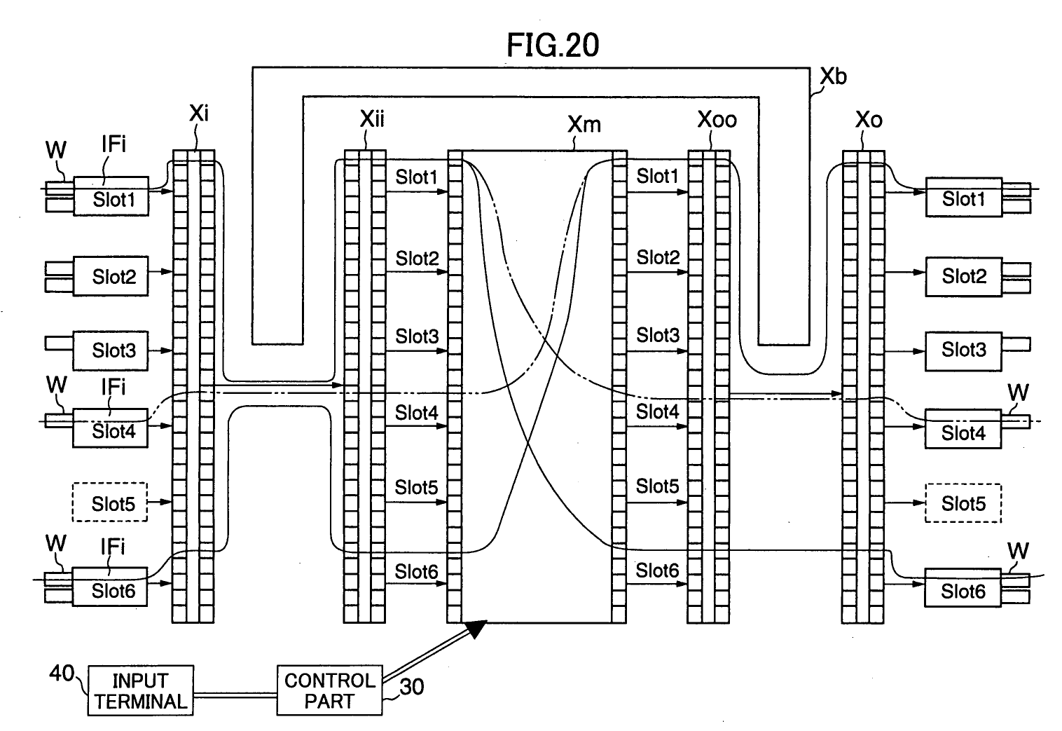

Furthermore, with the use of such a configuration of hardware, a desired test can be executed merely by making predetermined software setting, after the hardware (transmission apparatus NE) is connected with the testing apparatus 50 for line testing (test access) (see FIG. 9). Thereby, even in a case where a remotely located transmission apparatus NE3 is tested as shown in FIG. 19 or 20, the relevant test can be executed in a manner of remote control as a result of wiring connection being remotely controlled by means of software setting with the use of an instruction signal such as the above-mentioned TL1 command from the transmission apparatus NE2 which is present locally. In this case, cross connect setting achieves actual wiring connection as shown in FIG. 20, where solid lines represent cross connect setting for current regular operation lines while chain double-dashed lines represent cross connect setting for a testing purpose.

In this configuration shown in FIG. 20, by switching the cross connect setting from that for the current regular operation lines to that for the testing purpose in the transmission apparatus NE3 present locally, a cable wired from the testing apparatus 50 and connected to the ports in the slot Slot4 is then connected to the operation lines wired toward the remote transmission apparatus NE3 to be actually tested which are connected to the slot Slot1. And also, the operation lines wired from the transmission apparatus NE3 and connected to the ports in the slot Slot1 are then connected to the testing apparatus 50 wired from the ports in the slot Slot4. With the use of the thus-established wiring between the testing apparatus 50 and the remote transmission apparatus NE3, the remote transmission apparatus NE3 can be controlled remotely from the testing apparatus 50 so that connection setting of the cross connect matrix unit also in the transmission apparatus NE3 is performed therewith, and thus, line testing (test access) for the transmission apparatus NE3 can be executed finally.

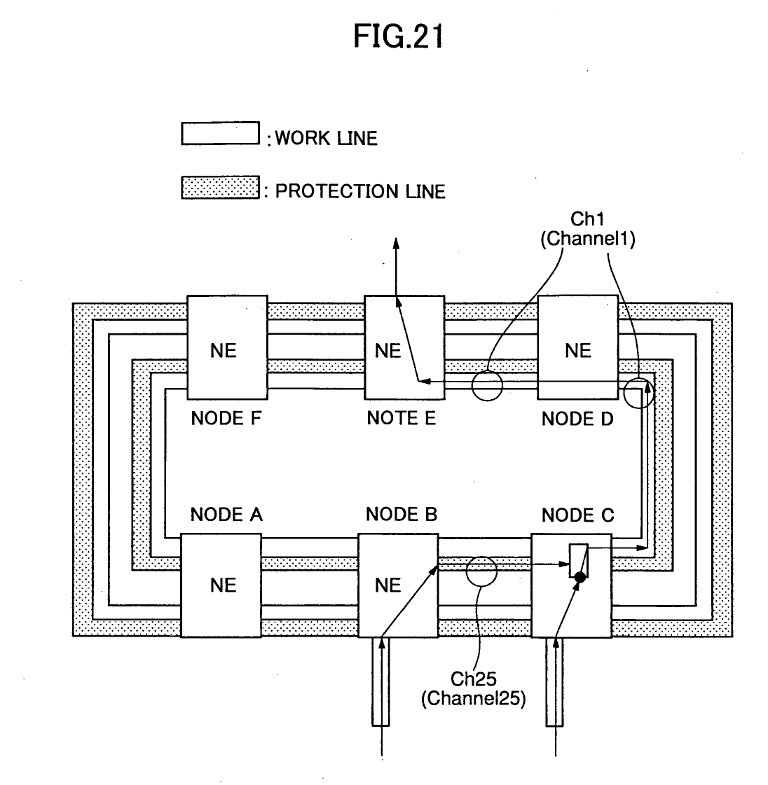

Furthermore, according to the present invention, it is possible to apply the cross connect matrix unit to a test which needs a predetermined selector, by providing a configuration enabling the cross connect matrix unit to function as a selector for selecting an arbitrary path from among a plurality of paths. As an example of line testing (test access) in such a case, an example applying a DCP (drop and continue on protection) configuration, mentioned above, is described next. That is, in a ring network such as that shown in FIG. 21, in a case where a so-called BLSR (bi-directional line switched ring) is configured therein, it is possible to configure a path network having a DCP configuration there. Specifically, an example of performing a line testing (test access) from a node C having a DCP configuration in the configuration shown in FIG. 21 is described next. In the configuration shown in FIG. 21, it is assumed that each node shown has the same configuration as that of the transmission apparatus NE according to the present invention described above.

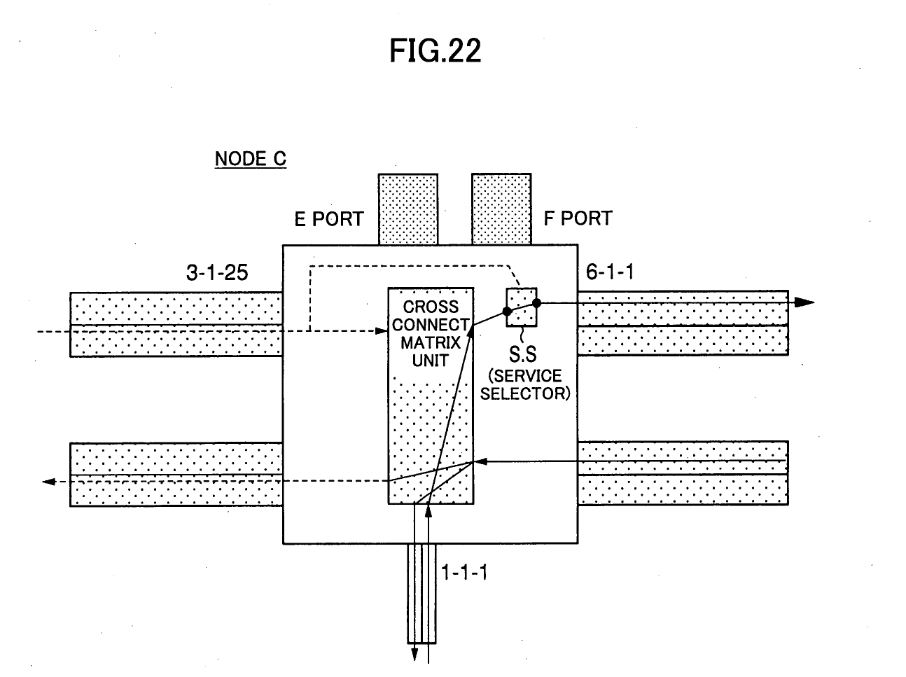

FIG. 22 shows a state of cross connect setting in the node C having the DCP configuration before testing. Since it has the DCP configuration, a signal to be transmitted through a path 6-1-1 shown is selected either as input received from a path 1-1-1 or as input received from a path 3-1-25, by means of a service selector (S.S). There has been no particular rule of performing a test as to which of these inputs should be selected, and thus, there has been no clear reference for selecting a path, in the related art. According to the embodiment of the present invention, a reference for selecting a path is determined so that the above-mentioned issue concerning path selection can be solved as will now be described.

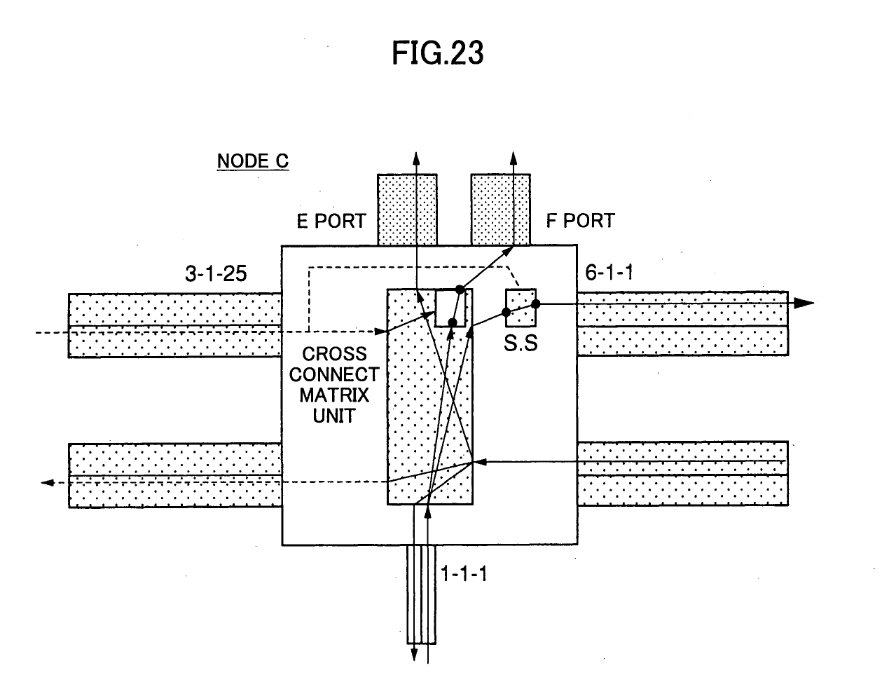

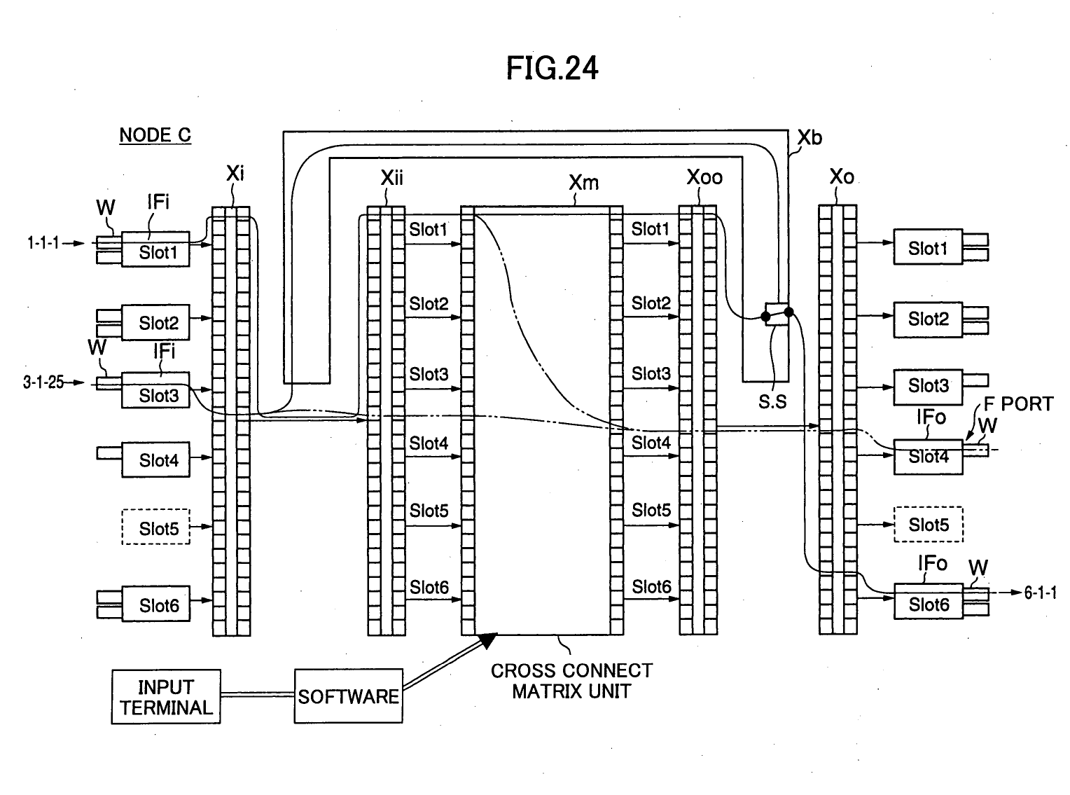

Specifically, when line testing (test access) is performed in the state shown in FIG. 22, connection setting shown in FIGS. 23 and 24 is performed according to an embodiment of the present invention. That is, a path selector having the same function as that of the service selector (S.S) provided for the output to the path 6-1-1 is configured in a transmission side part in the node C for the F port with the use of the cross connect matrix unit there. Thereby, either one of the input from the path 3-1-25 and the input from the path 1-1-1 can be selected, and thus, it becomes possible to achieve setting of test circuit connection by which a signal is transmitted through the F port, same as the signal which is actually transmitted to the path 6-1-1. As a result of providing such a configuration, even in a case where a trouble occurs by which switching setting in the service selector S.S should be changed, it is possible to perform path selection corresponding to this change in the service selector, in the path selector thus configured in the cross connect matrix unit in the node C. Thereby, it becomes possible to transmit a signal, actually transmitted to the path 6-1-1, also to the testing apparatus 50 through the F port, and thus, it is possible to monitor the same signal in the testing apparatus 50.

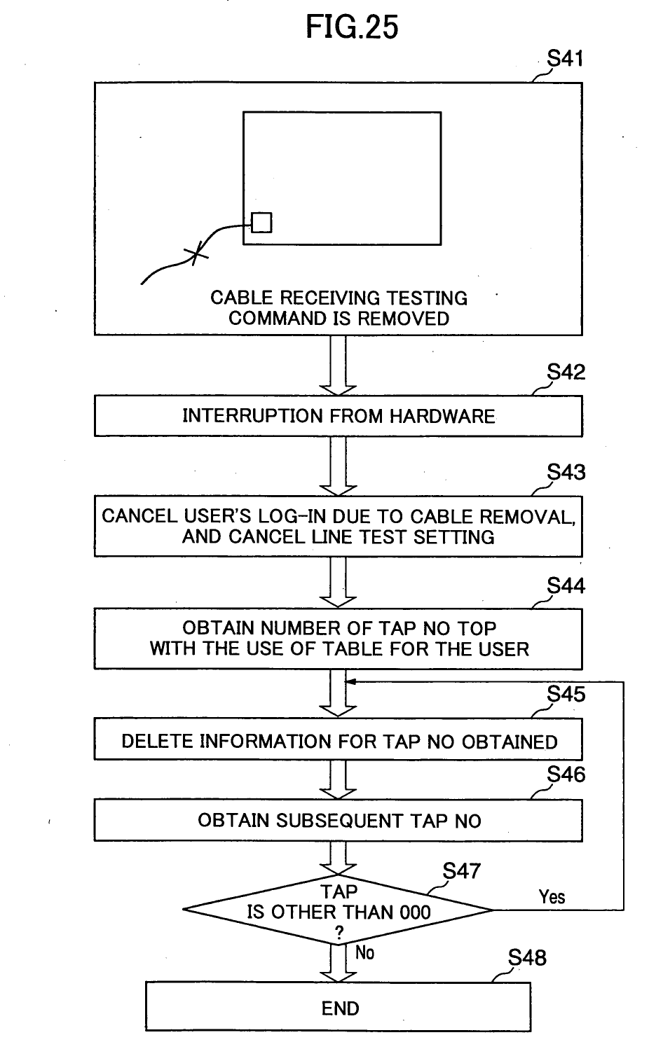

Furthermore, it is preferable that the hardware in the transmission apparatus NE in the embodiment of the present invention is configured to further enable an interrupt to be generated for the CPU in the control part 30 when an event of external cable removal or such occurs. That is, in a case where a LAN cable is removed, or in a case where a similar accident occurs, an interrupt is generated automatically, whereby this event is detectable by means of software in the control part 30, whereby setting for line testing (test access) previously made can be cancelled. FIG. 25 shows an operation flow chart of processing performed by the control part 30 upon occurrence of such an event as that of unexpected or accidental cable removal.

When removal of a cable which has been used to receive a command for line testing in Step S41 of FIG. 25, a relevant hardware originates an interrupt for the CPU in the control part 30 in Step S42. Thereby, in Step S43, a log-in state of a relevant user is cancelled, and relevant line testing (test access) setting is cancelled according to a relevant setting previously made in software. Then, in Step S44, for the relevant user, the top of TAP No. is obtained from the table shown in FIG. 16A, and, in Step S45, the information on the relevant TAP No. is deleted from the table shown in FIG. 16B. Further, in Step S46, the subsequent TAP No. is obtained from the table shown in FIG. 16B according to the NEXT TAP NO in the relevant line of the table. See arrows shown in FIGS. 16A and 16B for illustrating the operation in Steps S44, S45 and S46. Then, TAP No. is traced in sequence, one by one, by executing the loop of Steps S45 through S47, while the relevant information is deleted, one by one in sequence accordingly. Thus, all the TAP information for the relevant user is finally deleted. As a result, the TAP setting in the tables is returned to the state before the particular TAP setting for the relevant user was made. In other words, the cross connect setting in the transmission apparatus NE is returned to the state before the particular cross connect setting for the relevant line testing was set.

Thus, according to the present invention, in a transmission apparatus for which line testing (test access) is performed, units and ports which are normally used for connecting with regular operation lines, may be set for a purpose of line testing, and then, used for the testing purpose. Thereby, it is not necessary to previously provide a special configuration for the line testing, and thus, it is possible to effectively reduce costs required for the testing or the totally required costs. Furthermore, since it is possible to perform a test with the use of the configuration in the apparatus either for connecting with backbone network lines or for connecting with access lines (subscriber side lines) without discrimination in the hardware according to the present invention, it is possible to freely extend a scope of a data transmission system to be tested. Furthermore, since remote control with the use of software is made possible according to the present invention, it is not necessary to actually dispatch an operator to a station house in which an apparatus to be tested is located, and thus, necessary connection setting therein for a relevant test can be performed from anywhere.

Furthermore, in a test mode where a communication path having a predetermined selector thereon is tested, it is possible to monitor a signal from reception lines actually selected by the predetermined selector and thus to use the signal for a testing purpose, with the use of the method according to the present invention. Further, since units and ports prepared for regular operation lines are also used for a testing purpose, and setting may be performed depending on a mode in the test by which some lines used for testing should be disconnected, it is advantageous to provide a predetermined configuration by which accidental change in a line testing (test access) mode applied by an irrelevant user is avoidable for the purpose of improving the security.

Furthermore, a function may be provided by which cable removal is automatically detected, and thereby, setting for line testing (test access) is cancelled. Thereby, it is possible to avoid a problematic situation in which a state in which the test is stopped due to the accident continues unnecessarily for a long period. This function may also be used for the purpose of avoiding a problematic situation in which a cable connection is changed by unauthorized person, and thus, mode change is performed wrongly. Thus, security improvement is achieved also in this term.

Further, the present invention is not limited to the above-described embodiments, and variations and modifications may be made without departing from the basic concept of the present invention claimed below.

1. A transmission apparatus provided in a communication network and controlling connection in the circuit network, comprising:
a signal switching part configured to output input signals provided to a plurality of input ports then to a plurality of arbitrary output ports, respectively, and to arbitrarily set an operation line circuit and a line testing circuit.

2. The transmission apparatus as claimed in claim 1, wherein:
connection circuit setting operation performed by said signal switching part is performed by means of operation of setting a software program.

3. The transmission apparatus as claimed in claim 1, wherein:
said signal switching part has a configuration in which a plurality of change over switching parts are disposed and connected in a matrix manner.

4. The transmission apparatus as claimed in claim 1, comprising a configuration such that change in a circuit configuration set for line testing by a user other than a predetermined user is avoided.

5. The transmission apparatus as claimed in claim 1, comprising a configuration such that said signal switching part is returned to a state present before predetermined line testing operation when it is detected that an external wiring cable is disconnected during the predetermined line testing operation.
